(19) United States
(12) Patent Application Publication
(10) Pub. No.: US 2026/0352321 A1
(43) Pub. Date: Nov. 5, 2026

(54) SYSTEMS AND METHODS TO FACILITATE TERRESTRIAL NETWORK (TN) TO/FROM NON-TERRESTRIAL NETWORK (NTN) HANDOVER AND MOBILITY MANAGEMENT

(71) Applicant: AALYRIA TECHNOLOGIES, INC., LIVERMORE, CA (US)

(72) Inventor: STEFAN DRASKOCI, LONDON (GB)

(73) Assignee: AALYRIA TECHNOLIGIES, INC., LIVERMORE, CA (US)

(21) Appl. No.: 19/566,871

(22) Filed: Mar. 13, 2026

Related U.S. Application Data
(60) Provisional application No. 63/772,064, filed on Mar. 14, 2025.

(51) Int. Cl. H04B 7/185

(52) U.S. Cl. CPC H04B 7/18541; H04B 7/18526; H04B 7/1855

(57) ABSTRACT

The current disclosure takes advantage of dual SIM capabilities of certain mobile communication devices in combination with providing a new constellation controller to facilitate seamless terrestrial network (TN) to/from non-terrestrial network (NTN) handover and mobility management.

### CROSS REFERENCE TO RELATED APPLICATIONS

This application claims benefit under 35 U.S.C. §119(e) of Provisional U.S. Patent Application No. 63/772,064, filed Mar. 14, 2025, the contents of which is incorporated herein by reference in its entirety.

### TECHNOLOGICAL FIELD

The present disclosure is in the field of communications networks, particularly with respect to terrestrial and non-terrestrial networks.

### BACKGROUND

Ready access to connectivity between people has proven to be one of the key enablers of social and economic development. The proliferation of mobile networks has proven key and has, through its iterations, been deployed primarily in regions where it would see constant usage, i.e., areas of high population density and human mobility. Even in most developed countries, there are connectivity gaps where the deployment of terrestrial base stations has proven to be physically infeasible or commercially unavailable. FIG. 1 provides an example coverage map showing areas of continuous terrestrial mobile network coverage 100, areas of no mobile network coverage 102 and edges 104 between the coverage and non-coverage areas. Such remote regions historically could only be served with connectivity by proprietary satellite systems, however these have in most cases proven to be too inaccessible and impractical to the end user to see widespread adoption.

The 3GPP family of standards for mobile networks has achieved global adoption and usage and has given rise to billions of mobile devices which support a number of generations of the standard (3G, 4G, 5G, etc.). The combination of these standards with the ubiquitous reach of satellites presents a compelling solution to deliver connectivity to unconnected regions and people.

This opportunity was recognized in 3GPP and has been actively addressed in recent years as a new flavor of the 5G NR standard, called 5G Non-Terrestrial Networks (NTN). Referring to FIG. 2, the first enhancements for 5G NTN came in 2022 in the 3GPP Release 17, which addressed deployments which would utilize the satellite as a repeater of the 5G waveform which was generated on the ground. This kind of architecture is called a transparent, or bent-pipe, architecture. For several reasons, such as the ability for the mobile device’s transmission to reach the satellite in the Uplink direction, Low Earth Orbit (LEO) 200 satellite constellations are recognized as the preferred mode of delivery. As shown in FIG. 2, the 5G gNodeB 208 Radio Acces Network (RAN) stack generates the Downlink (DL) NR-Uu waveform that is transmitted by the NTN Gateway 206 to the LEO sateliite(s) 200 via a Feeder link 204, where the NR-Uu waveform is repeated, typically on another frequency, and retransmitted down to the terrestrial mobile device, a User Equipment (UE) 212, on the Service link 210. In contrast, the Uplink NR-Uu waveform follows the reverse path, being transmitted by the UE 212 via the Service link 210 to the LEO satellite(s) 200, where the signal is retransmitted via the Feeder link 204 down to the NTN Gateway 206 and 5G gNodeB 208 RAN.

Referring to FIG. 3, subsequent releases of 3GPP have been tackling the complexities of hosting a 5G gNodeB onboard satellites 300, and having the capability to route traffic flows over Inter-Satellite Links (ISLs) 302 to other satellites. These kinds of networks offer greater flexibility to the end-to-end delivery of connectivity, but in doing so they also increase operational complexity. Over time, Direct-to-Device 5G NTN services will evolve towards being capable of delivering higher data rates to the UE(s) 212 to support different services.

The market is trending towards 5G NTN constellations being owned and operated by incumbent and emerging Satellite Network Operators (SNOs), who are distinct to the terrestrial Mobile Network Operators (MNOs) whose coverage gaps they are filling. See, for example, FIG. 4, showing SNO coverage 400 filling coverage gaps 102 in the MNO coverage 100. Each independent 5G NTN constellation is intended to act as a logical extension of a number of 5G terrestrial networks all over the world, where the mobile devices are expected to roam onto the former in the absence of the latter. The end goal is to enable mobile users to consume connectivity services with minimal impact on their perceived experience, including seamless transitions/handovers between 5G Terrestrial Networks (TNs) and 5G NTNs. A key challenge in achieving this end goal is that the current 3GPP standards do not sufficiently address the architectural implementations and processes by which 5G TNs and NTNs will integrate and coordinate at the Radio Access Network (RAN) and Core levels, to allow mobile devices (UEs) to be seamlessly handed over from one to the other.

Terrestrial network coverage gaps are in some cases quite wide, while in other cases significantly smaller. A UE driving on a highway might leave, re-enter, and again leave the terrestrial coverage area 100 every couple of minutes. In order to assure seamless consumption of connectivity services, the network should be capable of maintaining voice and data-based conversations (e.g., WhatsApp) during the handovers between the TN and the NTN. Referring to FIG. 5, in handover events between terrestrial base stations, this is achieved either by having an interface between the two gNodeBs which allows them to coordinate (e.g., the Xn interface), or by having them do so via their common Core Network (e.g., via the NG interface). The establishment of this kind of interfacing on a global scale between the SNOs and various MNOs would be very difficult to achieve. As such, another key challenge is that current 3GPP standards for 5G NTN account for traditional mobile roaming between operators as being the handover procedure for transitions between the two, which would pose a significant interruption for a user to their consumption of connectivity services.

There are new NTN control plane signaling measures that were introduced by 3GPP to aid UEs for the initial access and mobility procedures, such as the System Information Block 19 (SIB19). These are intended to be unicast or broadcast by the TN RAN to UEs which are soon to be connected to the NTN network. The UEs use this information about their target satellite to properly synchronize in time and frequency with the NTN segment, to facilitate TN-to-NTN handover. This means that the TN RAN cells at the known terrestrial coverage edge 104 need to be (a) capable of such signaling in the first place, and (b) cognizant of the time-dynamic information about the NTN satellites flying overhead. Consequently, this introduces the following challenges: rollout of terrestrial 5G RAN infrastructure has been largely based on Release 15 Non-Standalone (NSA) architecture, whereas rollout of subsequent Releases’ Standalone (SA) infrastructure has been globally declining due to lack of commercial incentive. The majority of global terrestrial 5G RAN infrastructure will initially not contain the signaling capability to support Release 17 and later 5G NTN control signaling features. Additionally, before any SNO can provide truly ubiquitous NTN connectivity, it is likely that some SNOs will have partially deployed constellations. 5G NTN should allow mobile devices to connect to all of them.

### SUMMARY

The current disclosure takes advantage of dual SIM capabilities of certain UEs in combination with providing a new constellation controller to facilitate seamless terrestrial network (TN) to/from non-terrestrial network (NTN) handover and mobility management.

In a first aspect a method is provided for operating one or more constellation controllers for providing non-terrestrial networks (NTN) connectivity and facilitating terrestrial network (TN) to/from non-terrestrial network (NTN) handover and mobility management for terrestrial mobile communication devices. The method includes steps of: (A) receiving by a constellation controller, either (i) directly or (ii) via a proxy service, a query indicating that a terrestrial mobile communication device of defined capabilities, locality and level of service requirements may require non-terrestrial network (NTN) connectivity; (B) evaluating by the constellation controller the ability and cost of its non-terrestrial network (NTN) satellite constellation under control to provide the level of service requested by the terrestrial mobile communications device; (C) federating by the constellation controller with one or more instances of constellation controllers belonging to other NTN satellite network operators (SNOs) and, upon affirmative response of their ability to provide the level of service requested by the terrestrial mobile communication device, receiving SNO response information from one or more SNOs; (D) evaluating by the constellation controller between its own non-terrestrial network (NTN) under control and the obtained SNO response information from one or more SNOs to (i) choose an NTN SNO for providing NTN connectivity to the terrestrial mobile communication device or (ii) to allow another network service to choose an NTN SNO for providing NTN connectivity to the terrestrial mobile communication device; (E) building by the chosen constellation controller an NTN control plane signaling measure (e.g., System Information Block 19 (SIB19) from 3GPP Release 17) for a specific satellite of the chosen NTN SNO via which the terrestrial mobile communications device will perform initial network access; and (F) delivering by the constellation controller the built NTN control plane signaling measure and any associated SIM/eSIM identities to the terrestrial mobile communication device, either (i) directly or (ii) via a proxy service by means of an Application layer control channel over the currently present terrestrial network (TN) connectivity; whereby the terrestrial mobile communication device will use the delivered NTN control plane signaling measure to establish an active session with the first satellite of the chosen SNO prior to loss of terrestrial network (TN) connectivity.

In a more detailed embodiment, the method further includes the steps of: (X) determining by the constellation controller at play that the terrestrial mobile communications device will soon fall out of coverage of the current serving satellite, or that it will otherwise be unable to continue providing the level of service requested by the terrestrial mobile communications device; and (Y) handing over the active session to a second satellite before the terrestrial mobile communications device loses connectivity to the first satellite. In a further detailed embodiment, the second satellite is provided by the chosen SNO; and the method further includes a step of (Z) delivering by the constellation controller, directly or via a proxy service, by means of (i) an Application layer control channel over the currently present non-terrestrial network (NTN) connectivity, or (ii) a physical layer control channel of the currently present non-terrestrial network (NTN) connection’s mobile networking protocol stack, the subsequent supplemental NTN control plane signaling measure pertaining to the second satellite to aid intra-NTN satellite constellation (intra-SNO) handovers between satellites.

Alternatively, or in addition, in the case where the chosen SNO’s satellite constellation cannot continue providing the level of service requested by the terrestrial mobile communications device, and another SNO ought to be potentially employed, the method further includes a step of (T) federating by the constellation controller, upon lack of resources or ability to support subsequent intra-NTN satellite constellation (intra-SNO) handovers, with additional constellation controllers belonging to other NTN SNOs, to select the subsequent SNO and to facilitate an inter-NTN satellite constellation (inter-SNO) handover; (U) delivering by the constellation controller, directly or via a proxy service, by means of (i) an Application layer control channel over the currently present non-terrestrial network (NTN) connectivity, or (ii) a physical layer control channel of the currently present non-terrestrial network (NTN) connection’s mobile networking protocol stack, the subsequent supplemental NTN control plane signaling measure pertaining to the second satellite to aid inter-NTN satellite constellation (inter-SNO) handovers between satellites; and (V) delivering by the constellation controller, directly or via a proxy service, by means of an Application layer control channel over the currently present non-terrestrial network (NTN) connectivity any additional SIM/eSIM identity information needed to join the subsequent SNO.

In an embodiment, the SNO response information by the respective one or more instances of NTN satellite network operators (SNOs) includes information pertaining to the requirements, limitations (e.g. available landing rights) and/or associated costs of delivering the level of service requested by the terrestrial mobile communications device.

In a second aspect, a terrestrial mobile communications device is provided that includes a processor, an Operating System (OS), a background application/service connected to the constellation controller or proxy service via an Application layer control channel over the currently present terrestrial network (TN) connectivity, an eSIM capability, a Dual SIM Dual Active (DSDA) or custom time-multiplexed Dual SIM Dual Standby (DSDS) capability, a mobile network baseband chip with OS-programmable timing and frequency offset capability, and a non-transitory memory with computer instructions stored in the non-transitory memory. The computer instructions are configured to operate the processor to perform the following steps: (A) establishing, via a first SIM/eSIM of the dual-SIM capability, a preferred data connection with a terrestrial network (TN); (B) monitoring connectivity status with the terrestrial network (TN); (C) upon determining a likelihood of losing connectivity with the terrestrial network (TN) during the monitoring step, reporting such an event to the constellation controller or proxy service via the Application layer control channel over the currently present terrestrial network (TN) connectivity; (D) receiving from the constellation controller the NTN control plane signaling measure and SIM/eSIM identity to be used; (E) initiating a network access procedure, via the second SIM/eSIM of the dual-SIM capability, with a non-terrestrial network (NTN); (F) transferring the data connection from the current terrestrial network (TN) via the first SIM/eSIM to the chosen subsequent non-terrestrial network (NTN) via the second SIM/eSIM prior to losing connectivity with the current terrestrial network (TN); and (G) performing the equivalent steps in subsequent cases where the terrestrial mobile communications device is to be handed over between two non-terrestrial networks (NTNs) in an inter-NTN/inter-SNO handover scenario, as described above.

In a further detailed embodiment, the monitoring step (B) is performed either locally on the terrestrial mobile communications device or offloaded onto an externalservice and includes: (X) receiving global navigation satellite system (GNSS) coordinates associated with a terrestrial location of the terrestrial mobile communications device; (Y) taking as an input any available navigational aid configuration and data from the terrestrial mobile communications device that is currently in use to assist prediction of future movement; and (Z) recording live signal measurements from the home terrestrial network (TN) and any other such viable terrestrial networks (TNs).

Alternatively, or in addition, the determining step (C) includes determining that the terrestrial mobile communications device is approaching an edge of known terrestrial network (TN) coverage based upon comparing the coordinates, navigational aid data and live signal measurements with a map indicating known terrestrial network (TN) coverage, and is therefore a viable candidate for a handover to a non-terrestrial network (NTN).

Alternatively, or in addition, the initiating an access procedure step (E) includes receiving a non-terrestrial network (NTN) control plane signaling measure (e.g., System Information Block 19 (SIB19) from 3GPP Release 17) for a specific satellite belonging to an NTN satellite network operator (SNO) from the constellation controller or proxy service via the Application layer control channel over the currently present terrestrial network (TN) connectivity; and the transferring step (F) includes applying the information from SIB19 to instruct the onboard mobile network baseband chip with OS-programmable timing and frequency offset, establishing a parallel data connection with the satellite network operator (SNO) prior to loss of terrestrial network (TN) connectivity, and reconfiguring active user sessions to traverse the non-terrestrial network (NTN) connection.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 is an illustration of a prior art 5G NTN coverage map showing areas of continuous terrestrial mobile network coverage, areas of no mobile network coverage and edges between the coverage and non-coverage areas;

FIG. 2 is an illustration of a prior art 5G NTN, called a transparent or bent-pipe architecture, that utilizes a satellite as a repeater of the 5G waveform generated on the ground;

FIG. 3 is an illustration of a prior art 5G NTN network hosting 5G gNodeBs onboard satellites and having the capability to route traffic flows over Inter-Satellite Links (ISLs) to other satellites;

FIG. 4 is an illustration of a prior art 5G NTN coverage map showing the Satellite Network Operators (SNOs) coverage filling coverage gaps in the terrestrial Mobile Network Operators (MNOs) coverage;

FIG. 5 is an illustration of how a prior art network may operate in order to assure seamless consumption of connectivity services during handovers between the TN and the NTN either by having an interface between the two gNodeBs or via the common core network (e.g., via the NG interface);

FIG. 6. is an illustration of connectivity handover coverage for a 5G UE between a TN, a first NTN, a second NTN, and a TN, which may be the same TN or a different one, using two different SIM cards, in accordance with an embodiment;

FIG. 7 is an illustration of an exemplary user interface of an exemplary mobile device in accordance with an embodiment;

FIG. 8 is an illustration of an exemplary user interface associated with a constellation controller in accordance with an embodiment;

FIG. 9 is an illustration of an exemplary 5G NTN constellation controller in accordance with an embodiment;

FIG. 10 is an illustration of a 5G UE equipped with a daemon service that interacts with the UE’s modem and other RF subcomponents and interacts via an application layer in communication with a 5G NTN constellation controller in accordance with an embodiment;

FIG. 11 is an illustration of a 5G NTN constellation controller provisioning the beam/cell of a 5G UE with a needed configuration and resources in accordance with an embodiment;

FIG. 12 is an illustration of a currently serving satellite moving towards the horizon and evaluation the potential for the next handover, either to a satellite in its own constellation using the dedicated control plane of the 5G NTN RAN/Core protocol stack or using the Federation API to notify an OEM 5G NTN service ahead of any disruption;

FIG. 13 is an illustration of a 5G UE, such as a smartphone, that has evolved from standard DSDS to support DSDA or enhanced DSDS with advanced antenna and signal processing technology;

FIG. 14 is a flowchart illustrating a method for operating constellation controllers for providing NTN connectivity and facilitating TN to/from NTN handover and mobility management for terrestrial mobile communication devices; and

FIG. 15 is a flowchart illustrating a method implemented by computer instructions that are configured to operate a processor to perform connectivity handover for a 5G UE between a TN, a first NTN, a second NTN, and a TN, using two different SIM cards, in accordance with an embodiment.

### DETAILED DESCRIPTION

Modern 5G modems for mobile communications devices, such as Qualcomm’s Snapdragon Modem-RF family, have built in support for Dual SIM Dual Active (X70 and later) and Satellite (X75 and later) operation. Instead of relying on a global ecosystem MNOs and SNOs to integrate, the current disclosure utilizes the 5G UEs/terminals that are equipped with these Dual SIM and Satellite capabilities to act as their own bridge between the Terrestrial Network (TN) and the Non-Terrestrial Networks (NTN). As illustrated in FIG. 6, before the 5G UE loses connectivity with TN 600 (connected via SIM1), it would use a second SIM card (eSIM) to perform the initial access procedure to the NTN SNO1 (NTN1 602) above it (connected via SIM2). Likewise, handing over from NTN SNO1 (NTN1 602) to NTN SNO2 (NTN2 604), SIM1 would perform the initial access procedure before the handover; and handing over from NTN SNO2 (NTN2 604) to TN 606 (which may be the same TN as TN 600), SIM2 would perform the initial access procedure before that handover. And so forth.

To accomplish this, the current disclosure solves additional challenges. For a variety of SNOs and satellites, how would the 5G UE in every MNO TN find out for which satellite to perform frequency pre-compensation and time advance adjustments? What can be done to ensure that the 5G UE in its given location can be continuously provided with the kind of connectivity assurance it, by proxy of its user, has requested? As part of the solution described in further detail below, the current disclosure provides that the 5G UE interact (i) directly or (ii) via a proxy service with the 5G NTN constellation controller(s) to receive everything it needs to establish a network connection with a 5G NTN satellite.

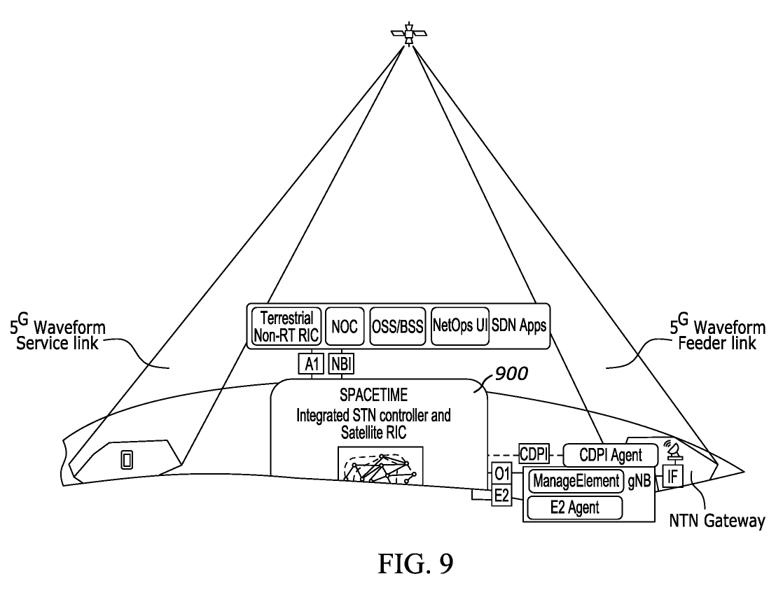

Referring to FIG. 9, the current disclosure provides an exemplary constellation controller (referred herein as “Spacetime”) 900. Spacetime is a fully fledged 5G NTN constellation controller, using its native interfaces, as well as open interfaces standardized by the O-RAN Alliance, to interact with 5G NTN RAN, as well as underlying Satellite Transport Network (STN) and its tasking. Spacetime facilitates intelligent and dynamic management of 5G NTN using standardized frameworks and interfaces, to result in the enhancement of their capabilities to account for the intricacies of 5G NTN networks.

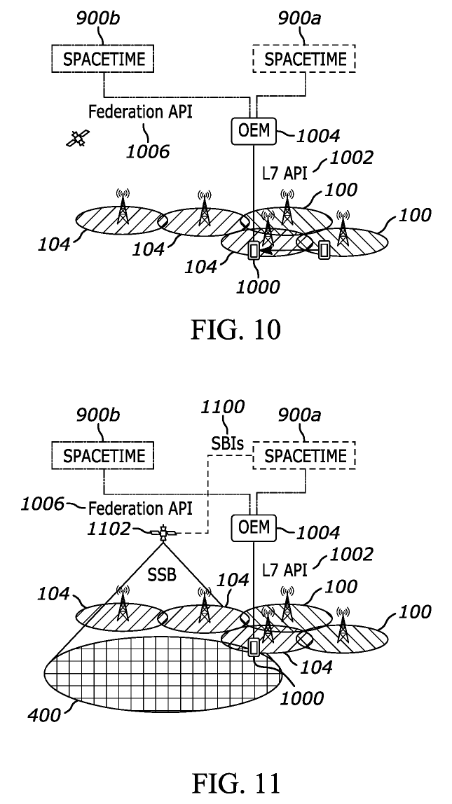

Referring to FIG. 10, in an embodiment a 5G UE 1000 is equipped with a daemon service running in its OS. The daemon on one end interacts with the UE’s modem and other RF subcomponents of the 5G UE that support 5G NTN and DSDA/DSDS, and on the other end interacts via an Application layer API 1002 with an OEM-operated NTN service 1004, which itself is communicating with one or more Spacetime instances 900a, 900b … 900x belonging to 5G NTN SNOs. The 5G UE 1000 user has previously been presented with a selection of NTN service levels (messaging, voice, data, etc.) at associated prices. These services may be delivered by one or more SNOs with availability dependent on how widespread their constellations are. The user has either defined a prepaid budget or a postpaid plan. This provides the 5G UE 1000 with one or more eSIMs which it can use to authenticate to the various 5G NTN networks.

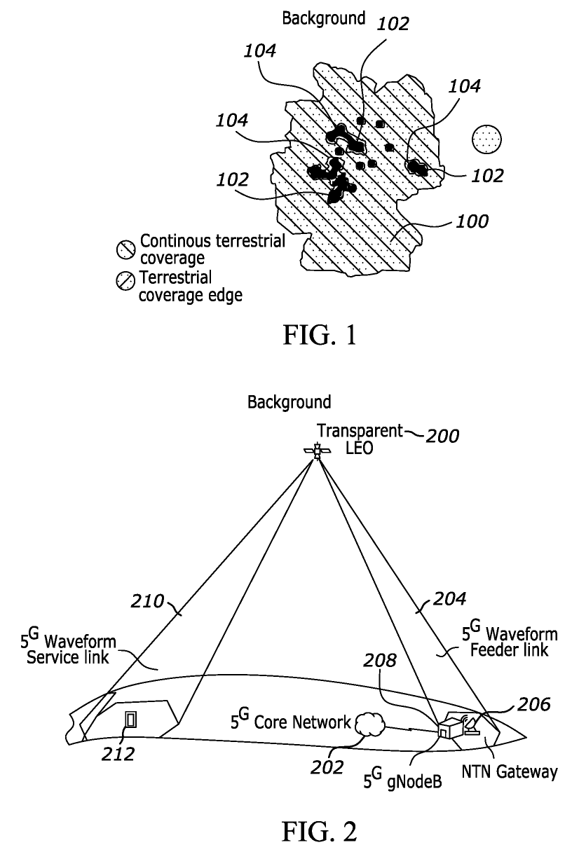

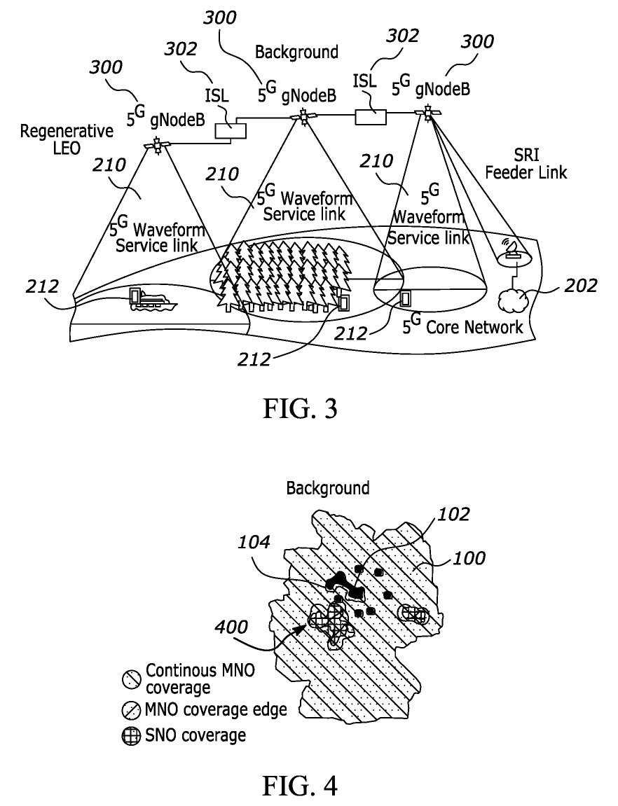

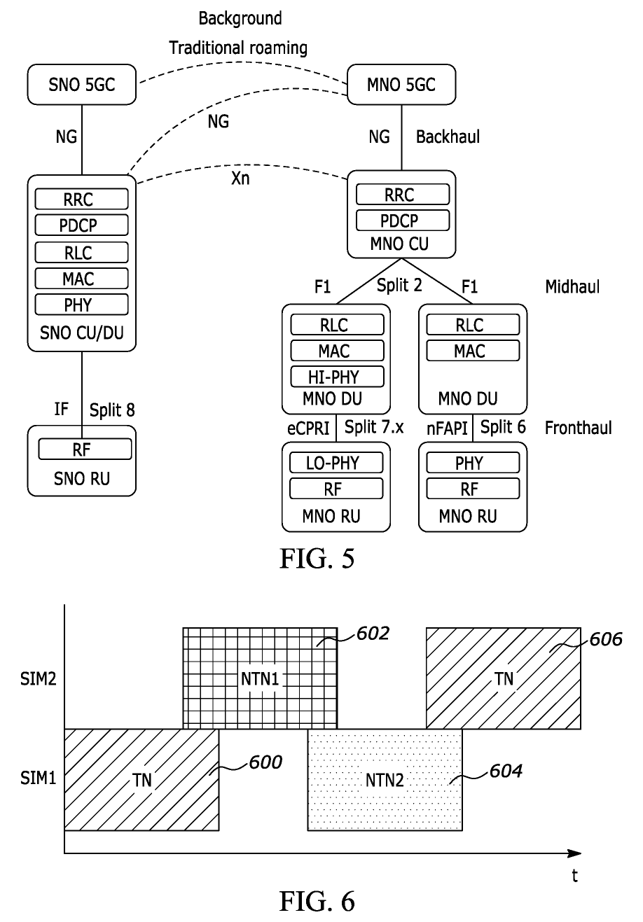

The 5G UE 1000 can retrieve its GNSS-derived coordinates to understand where it is with respect to a known coverage map (e.g., see FIG. 1). As the 5G UE 1000 is slowly approaching the known terrestrial coverage edge 104, it is using the Application layer API 1002 via the still present TN connection to report its coordinates to the OEM NTN service 1004, alongside other supplemental information such as TN signal measurements. These can be compared by the OEM NTN service 1004 against the known service coverage area of the 5G UE’s main MNO to understand the likelihood that the 5G UE will leave the TN coverage. If sufficiently high, the OEM NTN service 1004 uses a Federation API 1006 to query the Spacetime instances 900a, 900b, … 900x of partnered 5G NTN SNOs that offer the required levels of service. The Spacetime instances 900a, 900b, … 900x evaluate the current resource utilization and physical ability to serve the area by their respective 5G NTN constellations, evaluate the cost to provision a service at the requested level, and report it to the OEM NTN service 1004 who interacts with them to select the provider. The chosen 5G NTN SNO’s Spacetime 900a builds the control plane signaling measure (e.g. SIB19) for the specific satellite to be employed and communicates it to the OEM NTN service 1004 who subsequently delivers it to the 5G UE 1000 via the Application layer API 1002 on the TN connection, alongside any additional SIM/eSIM configuration.

Referring to FIG. 11, the 5G UE 1000 is now equipped with the necessary information and if not already present, the chosen Spacetime 900a uses its Southbound APIs (SBIs) 1100 to provision the beam/cell with the needed configuration and resources. The 5G UE 1000 uses the chosen SNO’s eSIM (SIM2) and the control plane signaling measure (e.g. SIB19) contents to synchronize and establish an active session with the 5G NTN satellite 1102, where it sits in the RRC_INACTIVE mode until the 5G UE 1000 is about to fully lose its TN connection. As the 5G UE 1000 is leaving the coverage area of the TN 100 & 104, and if the user was for example on a voice/video over IP call, the NTN connection enters RRC_CONNECTED mode and any of the networking configuration updates (e.g., the IP address) that have to happen on the video call server are made. This in practice achieves a make-before-break handover from the TN to the NTN segment. The OEM NTN service 1004 now maintains the Application layer API 1002 with the 5G UE 1000 via the NTN service.

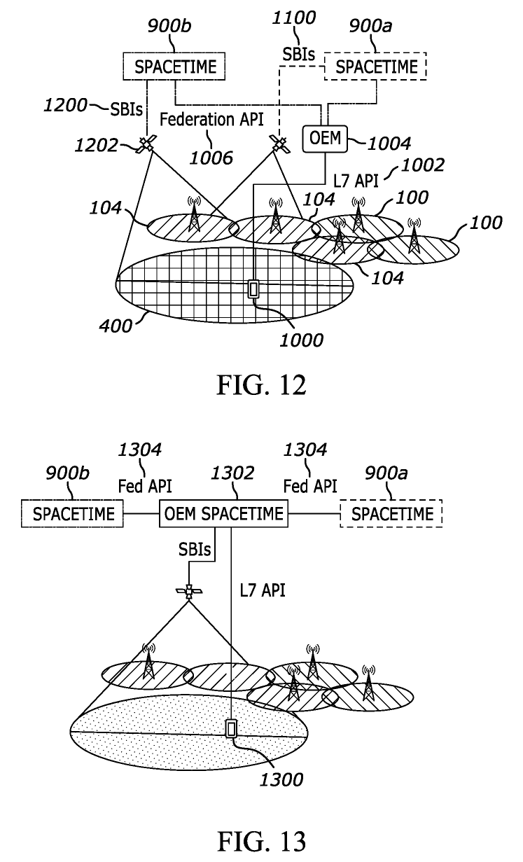

Referring to FIG. 12, as the currently serving satellite 1102 is moving towards the horizon, Spacetime 900a evaluates the potential for the next handover. This preferably involves a satellite in its own constellation, in which case the inter-beam and inter-satellite handovers would be facilitated using the dedicated control plane of the 5G NTN RAN/Core protocol stack. Alternatively, if the currently employed 5G NTN constellation is incomplete or otherwise unavailable, its Spacetime instance 900a can use the Federation API 1006 to notify the OEM 5G NTN service 1004 ahead of time that there will be a disruption. The OEM NTN service 1004 can then speak to the other partnered 5G NTN SNO’s Spacetime instances 900b … 900x to understand whether they can provide the service at the desired level instead. If this is the case and an SNO2 can deliver the service, its Spacetime 900b would provide the OEM NTN service 1004 with the updated control plane signaling measure (e.g. SIB19) via the Federation API 1006, which would be forwarded to the 5G UE 1000. Spacetime 900b would also use its SBIs 1200 to configure the second 5G NTN network 1202 to allocate resources to that beam/cell. The 5G UE 1000 could use the SNO2’s eSIM and DSDA/DSDS capability to join the other 5G NTN network 1202 before losing connectivity to the primary one 1102. The same configuration changes as before would happen, and the OEM NTN service 1004 would maintain connectivity with the 5G UE 1000 via an Application layer control channel over the SNO2’s network 1202.

Referring to FIG. 13, in an embodiment, a smartphone 1300 is provided that has evolved from standard DSDS to support DSDA or enhanced DSDS (using available Snapdragon or other modems) with advanced antenna and signal processing technology. In this embodiment, the OEM 1302 may directly manage its commercial agreements and terms with the upcoming 5G NTN D2D SNOs and may broker for the interaction between the end user and the SNO by bypassing the MNOs. In doing so, it can buy up NTN capacity in bulk and sell directly to users. Users of the OEM’s smartphones 1300 could enjoy a degree of flexibility in their global consumption of NTN services that would be otherwise infeasible if it was delivered via each MNO. In addition, the ability to experience seamless handovers between TN and NTN would come quicker than if it were enabled through the 3GPP standards route. The ability to reconfigure and sustain calls during these handover events could become a native feature of the specific smartphone or application. If the OEM 1302 were to consider operating its own 5G NTN constellation, it could operate this network with its own Spacetime instance, which could be partnered with other 5G NTN SNOs via the Federation API 1304 to deliver connectivity if the OEM’s own network cannot provide such connectivity using the handover methods described above with respect to FIG. 12.

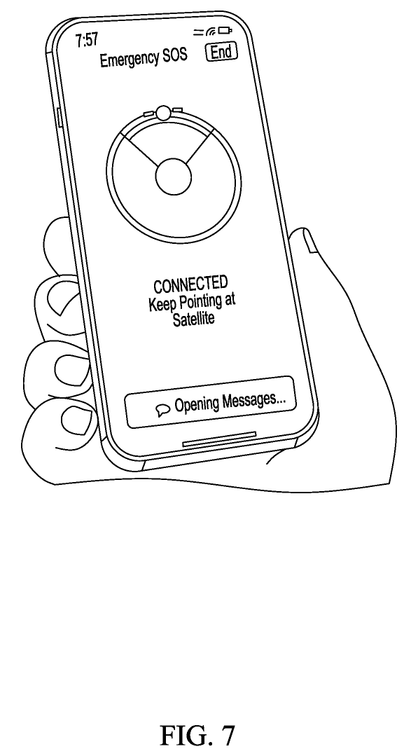

FIG. 7 provides an example user interface of an exemplary mobile device 212.

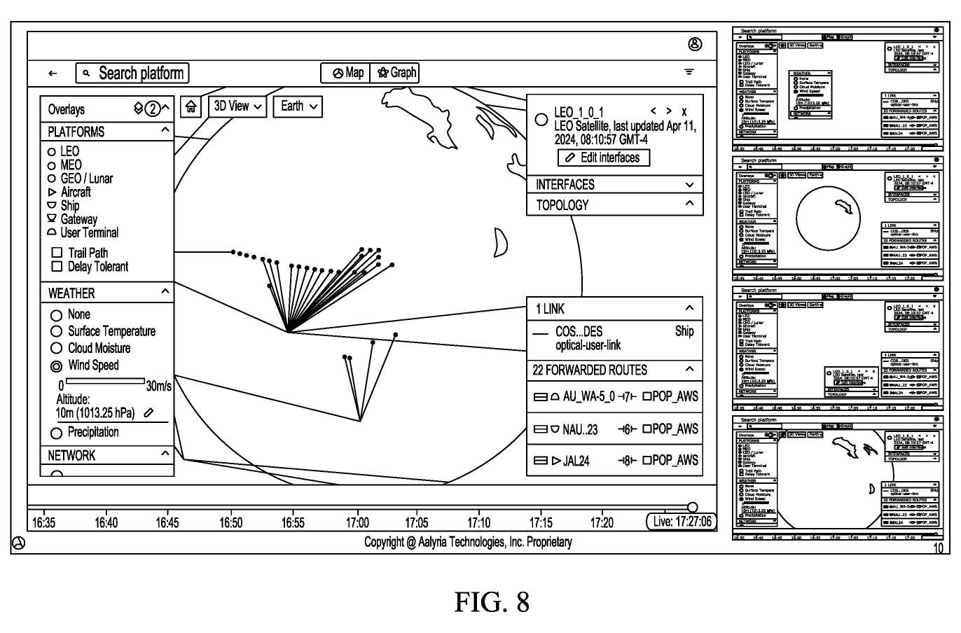

FIG. 8 provides an example user interface associated with a constellation controller. As shown, the constellation controller may keep track of weather conditions (e.g., wind-speeds) associated with satellite positioning, and may allocate more or less bandwidth based on weather conditions, orbit, trajectory and/or speed.

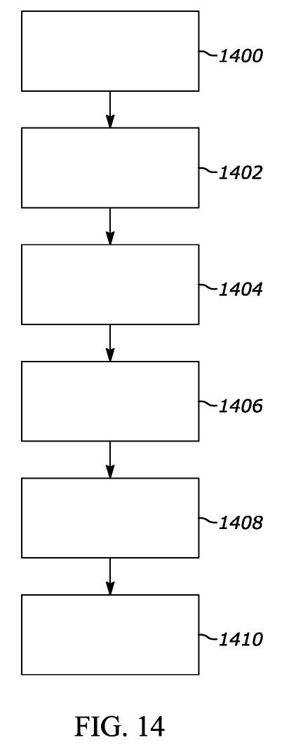

Following from the above, and referring to FIG. 14, the current disclosure provides a method for operating one or more constellation controllers for providing non-terrestrial networks (NTN) connectivity and facilitating terrestrial network (TN) to/from non-terrestrial network (NTN) handover and mobility management for terrestrial mobile communication devices. The method includes steps of: 1400 receiving by a constellation controller, either (i) directly or (ii) via a proxy service, a query indicating that a terrestrial mobile communication device of defined capabilities, locality and level of service requirements may require non-terrestrial network (NTN) connectivity; 1402 evaluating by the constellation controller the ability and cost of its non-terrestrial network (NTN) satellite constellation under control to provide the level of service requested by the terrestrial mobile communications device; 1404 federating by the constellation controller with one or more instances of constellation controllers belonging to other NTN satellite network operators (SNOs) and, upon affirmative response of their ability to provide the level of service requested by the terrestrial mobile communication device, receiving SNO response information from one or more SNOs; 1406 evaluating by the constellation controller between its own non-terrestrial network (NTN) under control and the obtained SNO response information from one or more SNOs to (i) choose an NTN SNO for providing NTN connectivity to the terrestrial mobile communication device or (ii) to allow another network service to choose an NTN SNO for providing NTN connectivity to the terrestrial mobile communication device; 1408 building by the chosen constellation controller an NTN control plane signaling measure (e.g., System Information Block 19 (SIB19) from 3GPP Release 17) for a specific satellite of the chosen NTN SNO via which the terrestrial mobile communications device will be perform initial network access; and 1410 delivering by the constellation controller the built NTN control plane signaling measure and any associated SIM/eSIM identities to the terrestrial mobile communication device, either (i) directly or (ii) via a proxy service; whereby the terrestrial mobile communication device will use the delivered NTN control plane signaling measure to establish an active session with the first satellite of the chosen SNO.

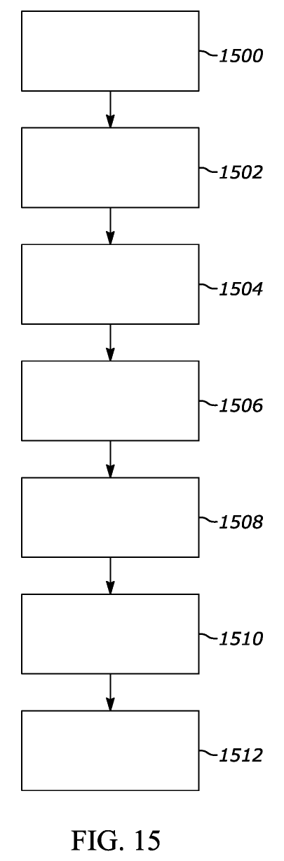

The current disclosure also provides a terrestrial mobile communications device that includes a processor, an Operating System (OS), a background application/service connected to the constellation controller or proxy service via an Application layer control channel over the currently present terrestrial network (TN) connectivity, an eSIM capability, a Dual SIM Dual Active (DSDA) or custom time-multiplexed Dual SIM Dual Standby (DSDS) capability, a mobile network baseband chip with OS-programmable timing and frequency offset capability, and a non-transitory memory with computer instructions stored in the non-transitory memory. Referring to FIG. 15, the computer instructions are configured to operate the processor to perform the following steps: 1500 establishing, via a first SIM/eSIM of the dual-SIM capability, a preferred data connection with a terrestrial network (TN); 1502 monitoring connectivity status with the terrestrial network (TN); 1504 upon determining a likelihood of losing connectivity with the terrestrial network (TN) during the monitoring step, reporting such an event to the constellation controller or proxy service via the Application layer control channel over the currently present terrestrial network (TN) connectivity; 1506 receiving from the constellation controller the NTN control plane signaling measure and SIM/eSIM identity to be used; 1508 initiating a network access procedure, via the second SIM/eSIM of the dual-SIM capability, with a non-terrestrial network (NTN); 1510 transferring the data connection from the current terrestrial network (TN) via the first SIM/eSIM to the chosen subsequent non-terrestrial network (NTN) via the second SIM/eSIM prior to losing connectivity with the current terrestrial network (TN); and 1512 performing the equivalent steps in subsequent cases where the terrestrial mobile communications device is to be handed over between two non-terrestrial networks (NTNs) in an inter-NTN/inter-SNO handover scenario, as described above.

Any of the methods or processes disclosed herein may be embodied as computer instructions stored in memory (such as a non-transitory memory device) for controlling one or more processors (e.g., resident on the mobile computing device or resident on the constellation controller) to perform some or all of the described steps or functionalities.

As used herein and in the appended claims, the singular forms "a," "and," and "the" include plural referents unless the context dictates otherwise. Thus, for example, reference to "a method" includes one or more such methods, and reference to "a constellation controller" includes reference to one or more constellation controllers and equivalents thereof known to those skilled in the art, and so forth. Similarly, any disclosed or claimed methods or process steps are not required to be performed sequentially unless the context of such steps otherwise requires sequential performance.

While particular embodiments of the current disclosure have been illustrated and described, it would be obvious to those skilled in the art that various other changes and modifications may be made without departing from the spirit and scope of the disclosed invention(s). It is, therefore, intended to cover in the appended claims all such changes and modifications that are within the scope of this invention(s). Further, it is intended that the claim terms are to be construed according to their customary and ordinary meanings in the relevant art unless such terms are explicitly defined otherwise herein.

1. A method for operating one or more constellation controllers for providing non-terrestrial networks connectivity and facilitating terrestrial network and non-terrestrial network handover and mobility management for mobile communication devices, comprising:
receiving by a constellation controller a query indicating that a terrestrial mobile communication device of defined capabilities, locality and level of service requirements may require non-terrestrial network connectivity;
evaluating by the constellation controller the ability and cost of its non-terrestrial network satellite constellation under control to provide the level of service requested by the terrestrial mobile communications device;
federating by the constellation controller with one or more instances of constellation controllers belonging to other satellite network operators and, upon affirmative response of their ability to provide the level of service requested by the terrestrial mobile communication device, receiving satellite network operator’s response information from one or more satellite network operators;
evaluating by the constellation controller between its own non-terrestrial network under control and the obtained satellite network operator’s response information from one or more satellite network operators to perform at least one of (a) choose a non-terrestrial network satellite network operator for providing non-terrestrial network connectivity to the mobile communication device or (b) to allow another network service to choose a non-terrestrial network satellite network operator for providing non-terrestrial network connectivity to the mobile communication device;
building by a constellation controller for the chosen satellite network operator an non-terrestrial network control plane signaling measure for a specific first satellite of the chosen satellite network operator via which the mobile communications device will be perform initial network access; and
delivering by the constellation controller the built non-terrestrial network control plane signaling measure and any associated SIM or eSIM identities to the mobile communication device;
whereby the mobile communication device will use the delivered non-terrestrial network control plane signaling measure to establish an active session with the first satellite of the chosen satellite network operator.

2. The method of claim 1, further comprising:
determining by the constellation controller that the mobile communications device will soon fall out of coverage of the current serving satellite or that it will otherwise be unable to continue providing the level of service requested by the terrestrial mobile communications device; and
handing over the active session to a second satellite before the terrestrial mobile communications device loses connectivity to the first satellite.

3. The method of claim 2, wherein the second satellite is provided by the chosen satellite network operator and the method further includes:
delivering by the constellation controller the subsequent supplemental non-terrestrial network control plane signaling measure pertaining to the second satellite to aid intra-non-terrestrial network satellite constellation handovers between satellites by at least one of (a) an Application layer control channel over the currently present non-terrestrial network connectivity or (b) a physical layer control channel of the currently present non-terrestrial network connection’s mobile networking protocol stack.

4. The method of claim 2, wherein the chosen satellite network operator satellite constellation cannot continue providing the level of service requested by the terrestrial mobile communications device and the method further includes:
federating by the constellation controller with additional constellation controllers belonging to other non-terrestrial network satellite network operators, to select the subsequent satellite network operator and to facilitate an inter-non-terrestrial network satellite constellation handover;
delivering by the constellation controller the subsequent supplemental non-terrestrial control plane signaling measure pertaining to the second satellite to aid inter-non-terrestrial network satellite constellation handovers between satellites by at least one of (a) an Application layer control channel over the currently present non-terrestrial network connectivity, or (b) a physical layer control channel of the currently present non-terrestrial network connection’s mobile networking protocol stack; and
delivering by the constellation controller any additional SIM or eSIM identity information needed to join the subsequent SNO by means of an Application layer control channel over the currently present non-terrestrial network connectivity.

5. The method of claim 1, wherein the satellite network response information by the respective one or more instances of non-terrestrial network satellite network operators includes information pertaining to at least one of requirements, limitations or associated costs of delivering the level of service requested by the mobile communications device.

6. A terrestrial mobile communications device including a processor, an Operating System (OS), a background application/service connected to the constellation controller or proxy service via an Application layer control channel over the currently present terrestrial network (TN) connectivity, an eSIM capability, a Dual SIM Dual Active (DSDA) or custom time-multiplexed Dual SIM Dual Standby (DSDS) capability, a mobile network baseband chip with OS-programmable timing and frequency offset capability, a non-transitory memory and computer instructions stored in the non-transitory memory, the computer instructions configured to operate the processor to perform the following steps:
establishing, via one of a first SIM or eSIM of the dual-SIM capability, a preferred data connection with a terrestrial network;
monitoring connectivity status with the terrestrial network;
upon determining a likelihood of losing connectivity with the terrestrial network during the monitoring step, reporting such an event to at least one of the constellation controller or proxy service via the Application layer control channel over the currently present terrestrial network connectivity;
receiving from the constellation controller the non-terrestrial network control plane signaling measure and SIM/eSIM identity to be used;
initiating a network access procedure, via one of a second SIM or eSIM of the dual-SIM capability, with a non-terrestrial network; and
transferring the data connection from the current terrestrial network via the first SIM or eSIM to the chosen subsequent non-terrestrial network via the second SIM or eSIM prior to losing connectivity with the current terrestrial network.

7. The terrestrial mobile communications device of claim 6, wherein the monitoring step includes:
receiving global navigation satellite system coordinates associated with a terrestrial location of the terrestrial mobile communications device.

8. The terrestrial mobile communications device of claim 7, wherein the determining step includes:
determining that the terrestrial mobile communications device is approaching an edge of known terrestrial network coverage based upon comparing the coordinates, navigational aid data and live signal measurements with a map indicating known terrestrial network coverage.

9. The terrestrial mobile communications device of claims claim 6, claim 7 or claim 8, wherein:
the initiating an access procedure step includes receiving a non-terrestrial network control plane signaling measure for a specific satellite belonging to an non-terrestrial network satellite network operator from the constellation controller or proxy service; and
the transferring step includes applying the information from the non-terrestrial network control plane signaling measure to instruct mobile network baseband chip with OS-programmable timing and frequency offset, establishing a parallel data connection with the satellite network operator prior to loss of terrestrial network connectivity, and reconfiguring active user sessions to traverse the non-terrestrial network connection.
